(19) United States
(12) Patent Application Publication
(10) Pub. No.: US 2019/0071982 A1
(43) Pub. Date: Mar. 7, 2019

(54) GAS TURBINE COMPONENT SELECTION AT MANUFACTURE

(71) Applicant: Siemens Aktiengesellschaft, München (DE)

(72) Inventor: Quentin Luc Balandier, Lincoln (GB)

(73) Assignee: Siemens Aktiengesellschaft, Munich (DE)

(21) Appl. No.: 16/085,181

(22) PCT Filed: Mar. 14, 2017
(86) PCT No.: PCT/EP2017/056025

§ 371 Date: Sep. 14, 2018

(30) Foreign Application Priority Data
Mar. 31, 2016 (EP) 16163279.9

(51) Int. Cl. F01D 5/28

(52) U.S. Cl. CPC F01D 5/28; F05D 2230/21; F05D 2300/17; F05D 2260/83; F05D 2230/25

(57) ABSTRACT

A method for manufacturing a number of gas turbine components includes selecting material for manufacturing a number of components, making at least one coupon of the material for testing of material properties, determining at least one required material property, a target value of the property and an acceptable deviation from the target value, testing the at least one determined material property of the coupon, associating each component, which is made of the selected particular material, with the at least one material property of the coupon, comparing the testing result of the property with the required material property, and rejecting components, the associated at least one property of which do not fulfil the acceptable deviation of the required value of the material property.

### CROSS REFERENCE TO RELATED APPLICATIONS

This application is the US National Stage of International Application No. PCT/EP2017/056025 filed Mar. 14, 2017, and claims the benefit thereof. The International Application claims the benefit of European Application No. EP16163279 filed Mar. 31, 2016. All of the applications are incorporated by reference herein in their entirety.

### FIELD OF INVENTION

The present invention relates to a method for manufacturing gas turbine components. Especially, the invention addresses the turbine blade tip clearance control problem and the component creep life, which is for example relevant for component creep life declaration.

### BACKGROUND OF INVENTION

For a given alloy, minimum material properties are conservatively used for material selection and blade or disc design. Ultimately, creep issues can be addressed through the alloy choice, the blade design, for example shrouded or shroudless design, the amount of cooling flow, thermal barrier coating (TBC) choice, etc. Moreover, creep issues can be addressed by limiting the component lives.

Typically quality tests are performed to ensure that the material properties of a part or group of parts are above a minimum specified value given in the alloy specification. Components are usually designed and assessed using a line at −3sigma value for a given property. From the 3sigma values for the properties considered, if the design targets are not

met, then “heavy” design changes, which are typically cost intensive, are introduced. Such design changes can be the use of another alloy with a higher minimum specification value or minimum 3sigma property value, more cooling flows added in the components, decision about blades shroud or shroudless designs, increase of the components wall thickness, etc.

### SUMMARY OF THE INVENTION

It is an objective of the present invention to provide an advantageous method for manufacturing a number of gas turbine components and a gas turbine, which provides a control of material properties at an early stage.

The objective is solved by a method for manufacturing a number of gas turbine components and a method for manufacturing a gas turbine as claimed. The depending claims define further developments of the present invention.

The inventive method for manufacturing a number, advantageously a plurality, of gas turbine components comprises the following steps: A material or primary material, for example a particular sample, for manufacturing a number of components or a batch of components is selected. At least one coupon of the material for testing of material properties is made or manufactured. At least one required material property, a target value of the property and an acceptable deviation from the target value are defined or determined. The at least one determined material property of the coupon is tested. Each component, which is made of the selected particular material, is associated with the at least one material property of the coupon. The testing result of the property is compared with the required material property. Components are refused or rejected, the associated at least one property of which do not fulfil the acceptable deviation of the required value of the material property.

The target value may be defined in the component design phase.

The acceptable deviation is defined by standard calculation methods of creep deformation or creep life. The targets for acceptable deformation and or life define the required minimum material property in the design.

Additionally, material properties can be classified. Accepted components can be separated by class of material properties. Furthermore, an engine type can be determined with respect to the requirements of the gas turbine to be manufactured. A class of material properties for this engine type can be determined and the components can be selected depending on the engine type and the determined class of material properties.

For example, an advantage is that engines for high performance ratings may be built from discs, vanes and blades with high class material properties. Engines for lower performance ratings may be built from discs, vanes and blades with lower class material properties. As a consequence and considering a manufacturing process this classification of material properties can lead to a reduction or elimination of parts scrappage that saves manufacturing cost. Further, each engine can be built with parts of corresponding in-service lives so that known servicing / replacement intervals can be scheduled and achieved. This is highly advantageous for users of the gas turbine engines who can schedule their operations accordingly. Engines with mixed high and low class material properties will require servicing/replacement intervals corresponding to the lowest class of material. This often means scrapping or replacing parts that have high class material and have not yet reached their full in-service life.

The idea of the invention is to use testing at manufacture, using coupons, for example creep coupons made from the casting or forging of a batch of components to define the position of the batch or component within the material properties scatter band.

Advantageously a number of similar or identical gas turbine components are manufactured from the same material sample. This has the advantage that the single components do not have to be tested individually.

Generally casted and/or forged material can be used. The method may comprise the casting and/or forging process.

Preferably a gas turbine rotor component or a gas turbine stator component is manufactured, for example a gas turbine blade or a gas turbine vane or a gas turbine disc.

In a variant the creep strength and/or the proof strength or yield strength is determined as required material property. For instance, a tip clearance target and/or a creep life target are determined. As there is a correlation between proof strength and creep strength, proof strength coupons can also be used.

From the coupon results, each batch or component can be associated with specific creep properties. If the properties are too low against a blade tip clearance target or creep life target, the bad components should be scrapped.

Generally the method can comprise defining or determining a lower limit or lower threshold value for the specific material property and selecting components for a further manufacturing process, which associated value of the specific property is above the lower limit or lower threshold value. Additionally or alternatively, the method can comprise defining or determining an upper limit or upper threshold value for the specific material property and selecting components for a further manufacturing process, which associated value of the specific property is below the upper limit or upper threshold value.

The method for manufacturing a gas turbine comprises a method for manufacturing a number of gas turbine components as previously described. The method for manufacturing a gas turbine has the same properties and advantages as the previously described method for manufacturing a number of gas turbine components.

In a variant one coupon per component is used. Alternatively, several or more than one coupon per component can be used.

Artificially, the inventive method allows selectively improving the creep strength to a required level. The level of rejection is linked to improve blade tip clearance or creep lives to a required level.

The invention provides a selective process using coupons test at manufacture, for instance creep stress testing directly or proof stress testing.

The invention generally has the advantages that it simplifies the engine design. Moreover, the invention improves the creep capability of a given alloy to a required level. Furthermore, for a specific alloy the invention enables to control the tip clearance to a required level, and hence improves the engine performance.

Overall, the invention avoids the “heavy” and then costly designs decisions described above through components selection or classification at manufacture.

### BRIEF DESCRIPTION OF THE DRAWINGS

The above mentioned attributes and other features and advantages of this invention and the manner of attaining them will become more apparent and the invention itself will be better understood by reference to the following description of embodiments of the invention taken in conjunction with the accompanying drawings. The embodiments do not limit the scope of the present invention which is determined by the appended claims. All described features are advantageous as separate features or in any combination with each other.

FIG. 1 schematically shows part of a turbine engine in a sectional view.

FIG. 2 shows an example for coupon material test results.

FIG. 3 illustrates an increase of the minimum strength value.

FIG. 4 shows material test results for an alloy A.

FIG. 5 shows material test results for an alloy B.

FIG. 6 shows the results of FIG. 4 with a new design value.

FIG. 7 shows a classification of the tested coupons and the definition of material classes.

FIG. 8 schematically shows an example for a method for manufacturing a number of gas turbine components in form of a flow chart.

### DETAILED DESCRIPTION OF THE INVENTION

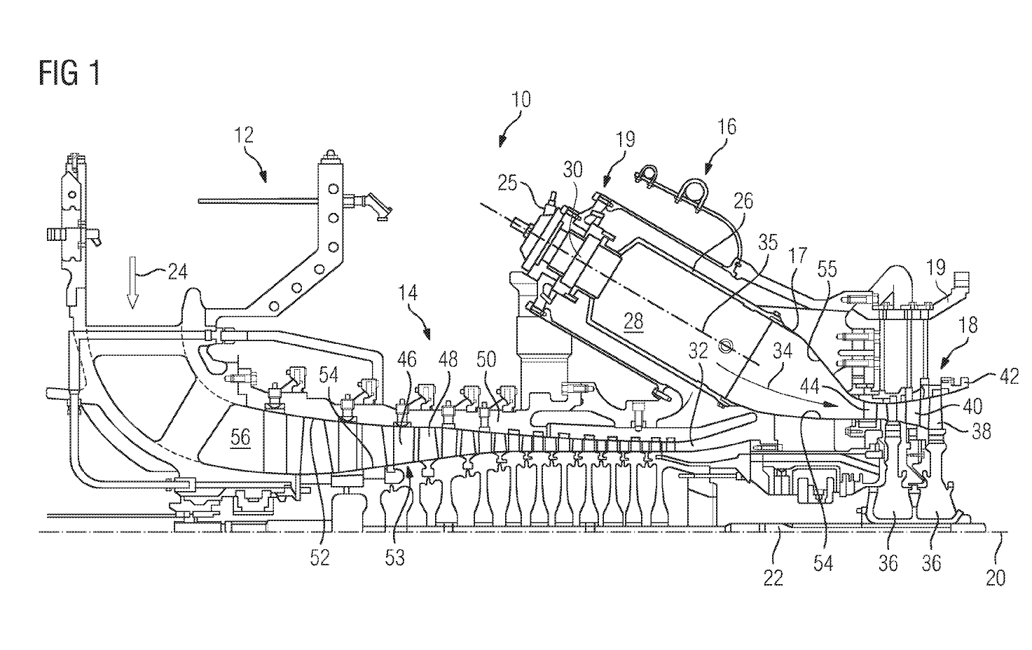

FIG. 1 shows an example of a gas turbine engine 10 in a sectional view. The gas turbine engine 10 comprises, in flow series, an inlet 12, a compressor section 14, a combustor section 16 and a turbine section 18 which are generally arranged in flow series and generally about and in the direction of a longitudinal or rotational axis 20. The gas turbine engine 10 further comprises a shaft 22 which is rotatable about the rotational axis 20 and which extends longitudinally through the gas turbine engine 10. The shaft 22 drivingly connects the turbine section 18 to the compressor section 14.

In operation of the gas turbine engine 10, air 24, which is taken in through the air inlet 12 is compressed by the compressor section 14 and delivered to the combustion section or burner section 16. The burner section 16 comprises a burner plenum 26, one or more combustion chambers 28 and at least one burner 30 fixed to each combustion chamber 28. The combustion chambers 28 and the burners 30 are located inside the burner plenum 26. The compressed air passing through the compressor 14 enters a diffuser 32 and is discharged from the diffuser 32 into the burner plenum 26 from where a portion of the air enters the burner 30 and is mixed with a gaseous or liquid fuel. The air/fuel mixture is then burned and the combustion gas 34 or working gas from the combustion is channelled through the combustion chamber 28 to the turbine section 18 via a transition duct 17.

This exemplary gas turbine engine 10 has a cannular combustor section arrangement 16, which is constituted by an annular array of combustor cans 19 each having the burner 30 and the combustion chamber 28, the transition duct 17 has a generally circular inlet that interfaces with the combustor chamber 28 and an outlet in the form of an annular segment. An annular array of transition duct outlets form an annulus for channelling the combustion gases to the turbine 18.

The turbine section 18 comprises a number of blade carrying discs 36 attached to the shaft 22. In the present example, two discs 36 each carry an annular array of turbine blades 38. However, the number of blade carrying discs could be different, i.e. only one disc or more than two discs. In addition, guiding vanes 40, which are fixed to a stator 42 of the gas turbine engine 10, are disposed between the stages of annular arrays of turbine blades 38. Between the exit of the combustion chamber 28 and the leading turbine blades 38 inlet guiding vanes 44 are provided and turn the flow of working gas onto the turbine blades 38.

The combustion gas from the combustion chamber 28 enters the turbine section 18 and drives the turbine blades 38 which in turn rotate the shaft 22. The guiding vanes 40, 44 serve to optimise the angle of the combustion or working gas on the turbine blades 38.

The turbine section 18 drives the compressor section 14. The compressor section 14 comprises an axial series of vane stages 46 and rotor blade stages 48. The rotor blade stages 48 comprise a rotor disc supporting an annular array of blades. The compressor section 14 also comprises a casing 50 that surrounds the rotor stages and supports the vane stages 48. The guide vane stages include an annular array of radially extending vanes that are mounted to the casing 50. The vanes are provided to present gas flow at an optimal angle for the blades at a given engine operational point. Some of the guide vane stages have variable vanes, where the angle of the vanes, about their own longitudinal axis, can be adjusted for angle according to air flow characteristics that can occur at different engine operations conditions.

The casing 50 defines a radially outer surface 52 of the passage 56 of the compressor 14. A radially inner surface 54 of the passage 56 is at least partly defined by a rotor drum 53 of the rotor which is partly defined by the annular array of blades 48.

The present invention is described with reference to the above exemplary turbine engine having a single shaft or spool connecting a single, multi-stage compressor and a single, one or more stage turbine. However, it should be appreciated that the present invention is equally applicable to two or three shaft engines and which can be used for industrial, aero or marine applications.

The terms upstream and downstream refer to the flow direction of the airflow and/or working gas flow through the engine unless otherwise stated. The terms forward and rearward refer to the general flow of gas through the engine. The terms axial, radial and circumferential are made with reference to the rotational axis 20 of the engine.

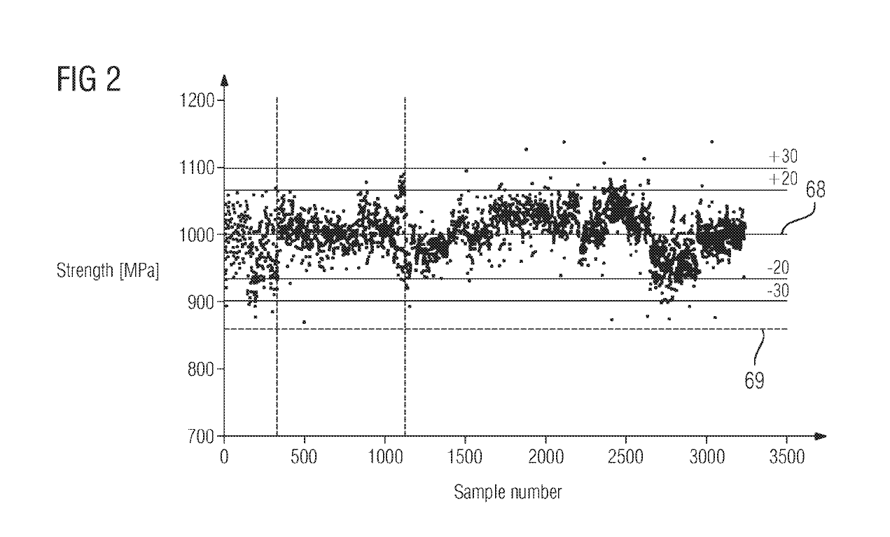

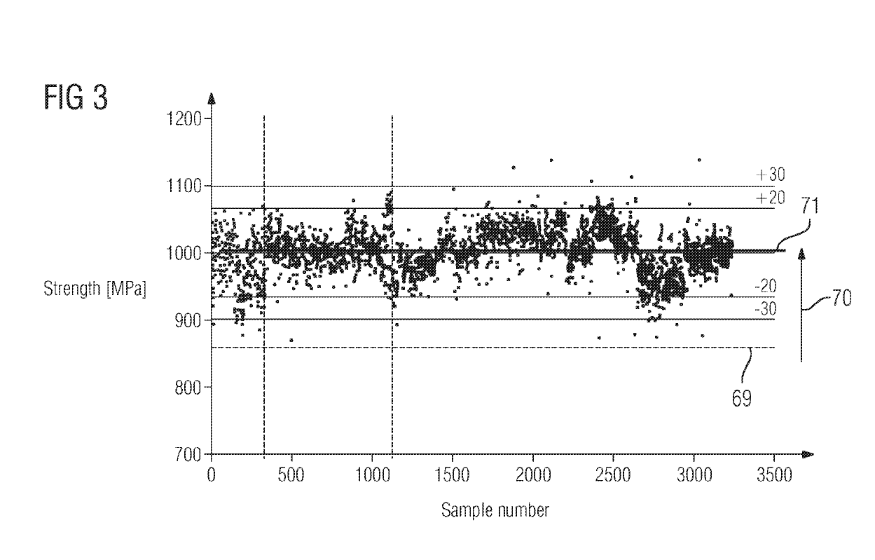

For example, FIG. 2 and FIG. 3 show the quality coupons test results and the minimum specification line 69 for a given property. The x-axis shows the sample number, the y-axis shows the strength in MPa. The average strength value is indicated by a horizontal line 68. Further horizontal lines indicate the +/−2sigma and +/−3sigma values. The line 69 is the minimum value according to the material specification.

FIG. 3 shows the coupon material test results of FIG. 2 and illustrates an increase 70 of the minimum strength value, indicated by line 71. The components are usually designed and assessed using a line at −3sigma value for a given property 68. For instance in case of a high rejection rate the minimum value can be increased.

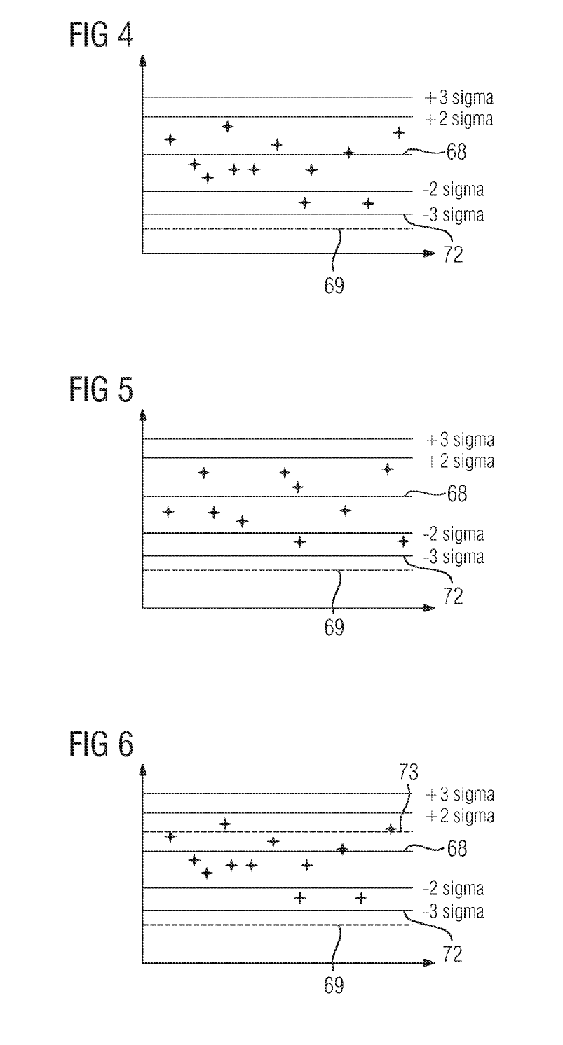

FIG. 4 shows material test results for an alloy A. FIG. 5 shows material test results for an alloy B. The design value in these examples is the −3 sigma value 72. FIG. 6 shows the results of FIG. 4 with a new design value 73.

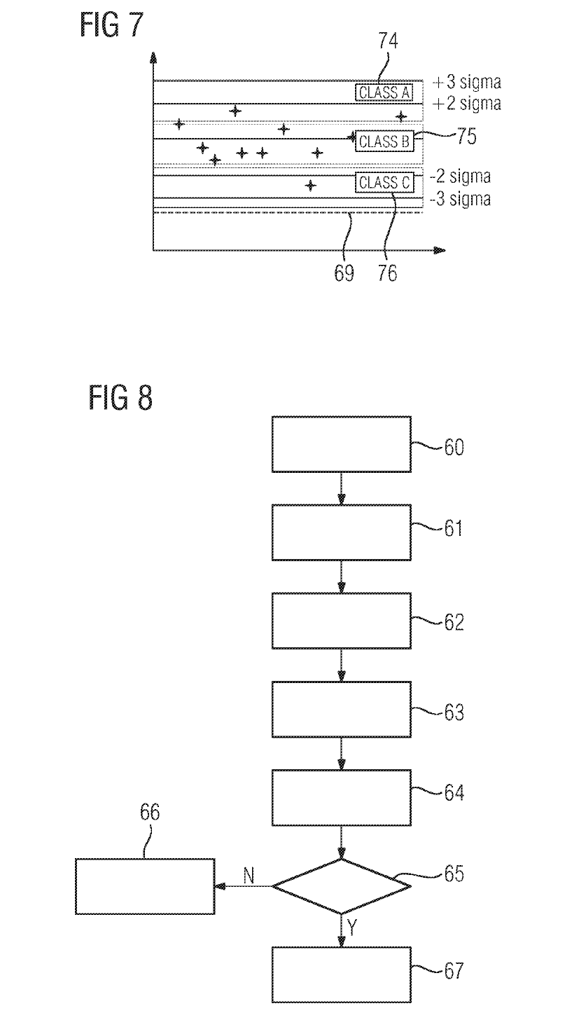

FIG. 7 shows the results of FIG. 6 with a classification of the tested coupons. The components associated with the coupons are separated by class of material properties, in the present example Class A (reference numeral 74), Class B (reference numeral 75) and Class C (reference numeral 76). The process can be used for several component types to define different Bill of Materials, e.g. Class A disc & blades, Class B discs & blades. Then for a given engine type, for example engines for high power rating can be built from class A Bill of Material components, medium power rating can be built for class B components, etc . . . .

FIG. 8 schematically shows an example for a method for manufacturing a number of gas turbine components in form of a flow chart.

In step 60 a material or primary material, for example a particular sample, for manufacturing a number of components or a batch of components is selected. In step 61 at least one coupon of the material for testing of material properties is made or manufactured. The manufacturing process of the number of components can be interrupted at this point until the coupon testing is finished or it can be continued.

In step 62 at least one required material property, a target value of the property and an acceptable deviation from the target value are defined or determined. In step 63 the at least one determined material property of the coupon is tested. In step 64 each component, which is made of the selected particular material, is associated with the at least one material property of the coupon.

In step 65 the testing result of the property is compared with the required material property. In other words it is asked if the associated property fulfils the acceptable deviation of the required value of the material property. If the answer is yes, the manufacturing process of the component or components is continued, as indicated by step 67. If the answer is no, the component or components is/are rejected, as indicated by step 66. This means that the manufacturing process of the component or components is stopped.

Additionally material properties can be classified, for example Class A, Class B, Class C and so on. The accepted components can be separated by class of material properties, for example Class A components, Class B components and Class C components, as for instance shown in FIG. 7.

Furthermore, an engine type can be determined with respect to the requirements of the gas turbine to be manufactured. A class of material properties for this engine type can be determined and the components can be selected depending on the engine type and the determined class of material properties.

Generally the method can comprise defining or determining a lower limit or lower threshold value for the specific material property and selecting components for a further manufacturing process, which associated value of the specific property is above the lower limit or lower threshold value. Additionally or alternatively, the method can comprise defining or determining an upper limit or upper threshold value for the specific material property and selecting components for a further manufacturing process, which associated value of the specific property is below the upper limit or upper threshold value.

Generally casted and/or forged material can be used. The method may comprise the casting and/or forging process.

Preferably a gas turbine rotor component or a gas turbine stator component is manufactured, for example a gas turbine blade or gas turbine vane or gas turbine disc.

In a variant the creep strength and/or the proof strength or yield strength is determined as required material property. For instance, a tip clearance target and/or a creep life target are determined. As there is a correlation between proof strength and creep strength, proof strength coupons can also be used.

1. A method for manufacturing a number of gas turbine components, comprising:
selecting material for manufacturing a number of components,
making at least one coupon of the material for testing of material properties,
determining at least one required material property, a target value of the property and an acceptable deviation from the target value,
testing the at least one determined material property of the coupon,
associating each component, which is made of the selected particular material, with the at least one material property of the coupon,
comparing the testing result of the property with the required material property, and
rejecting components, the associated at least one property of which do not fulfil the acceptable deviation of the required value of the material property.

2. The method, as claimed in claim 1, further comprising:
classifying material properties and separating accepted components by class of material properties.

3. The method, as claimed in claim 2, further comprising:
determining an engine type with respect to the requirements of the gas turbine to be manufactured, determining a class of material properties for this engine type and selecting the components depending on the engine type and the determined class of material properties.

4. The method, as claimed in claim 1, further comprising:
selecting casted and/or forged material.

5. The method, as claimed in claim 1, further comprising:
manufacturing a gas turbine rotor component or a gas turbine stator component.

6. The method, as claimed in claim 5, further comprising:
manufacturing a gas turbine blade or a gas turbine vane or a gas turbine disc.

7. The method, as claimed in claim 1, further comprising:
determining creep strength and/or proof strength as required material property.

8. The method, as claimed in claim 1, further comprising:
determining a tip clearance target and/or a creep life target.

9. A method for manufacturing a gas turbine, comprising:
manufacturing a number of gas turbine components by the method as claimed in claim 1.

10. The method for manufacturing a gas turbine, as claimed in claim 9, further comprising:
using one coupon per component.

11. The method for manufacturing a gas turbine, as claimed in claim 9, further comprising:
using several coupons per component.
